(19) United States
(12) Patent Application Publication
(10) Pub. No.: US 2018/0151093 A1
(43) Pub. Date: May 31, 2018

(54) Identification Holder

(71) Applicants: Kenan Willis, Brandywine, MD (US); Donald Gooding, JR., Brandywine, MD (US)

(72) Inventors: Kenan Willis, Brandywine, MD (US); Donald Gooding, JR., Brandywine, MD (US)

(21) Appl. No.: 15/819,861

(22) Filed: Nov. 21, 2017

Related U.S. Application Data
(60) Provisional application No. 62/426,938, filed on Nov. 28, 2016.

(51) Int. Cl. G09F 3/20

(52) U.S. Cl. CPC G09F 3/203

(57) ABSTRACT

An identification holder. The identification holder includes a base having a rectangular perimeter, a front side, and a rear side. A living hinge is disposed at a center of the base, such the living hinge divides the base into a first half and an adjacent second half. A plurality of transparent sleeves are disposed on the front side of the base, each sleeve including an open upper end and a closed lower end. One or more opaque pockets are disposed on the front side of the base, each of the one or more opaque pocket including an open upper end and a closed lower end. One or more clips are secured to the base. The one or more clips are configured to removably secure the identification holder to a vehicle window.

### CROSS REFERENCE TO RELATED APPLICATIONS

This application claims the benefit of U.S. Provisional Application No. 62/426,938 filed on Nov. 28, 2016. The above identified patent application is herein incorporated by reference in its entirety to provide continuity of disclosure.

### BACKGROUND OF THE INVENTION

The present invention relates to identification holders. More specifically, the present invention provides an identification holder that includes multiple sleeves and pockets for visibly holding identification materials, as well as fasteners for securing the identification holder to a vehicle window.

When a vehicle is pulled over by a police officer, the police officer typically orders the driver to produce their driver's license, their vehicle insurance card, and their vehicle state registration documents. These items are often stored in a center console or glove compartment where they are difficult to access. The driver may need to sort through may items in order to locate the required documents, which is frustrating and time-consuming. Additionally, the police officer may misinterpret the driver's action of reach for the requested documents as searching for a weapon or another sort of aggressive act, and may respond defensively. This could escalate the traffic stop to a dangerous situation and put the lives of both the police officer and the driver of the vehicle in great danger. It is therefore desirable to provide an identification holder that can hold and display multiple forms of documents and identification. Further, it is desirable to provide an identification holder that includes clips or other fasteners for securing the identification holder to the exterior of the vehicle prior to a police officer approaching the vehicle, increasing overall safety of both the driver and the police officer.

Devices have been disclosed in the known art relating to identification holders. However, the devices in the known art have several drawbacks. The devices in the known art fail to provide identification holder that includes a large base and multiple sleeves and pockets for supporting different types and sizes of identification or other important documents. The devices in the known art further fail to provide an identification holder that includes clips for securing the identification holder to a vehicle window, such that the stored identification and other documents are visible to an individual outside of the vehicle, such as a police officer.

In light of the devices disclosed in the known art, it is submitted that the present invention substantially diverges in design elements from the known art and consequently it is clear that there is a need in the art for an improvement to existing identification holders. In this regard the present invention substantially fulfills these needs.

### SUMMARY OF THE INVENTION

In view of the foregoing disadvantages inherent in the known types of identification holders now present n the prior art, the present invention provides an identification holder wherein the same can be utilized for providing convenience for the user when visibly storing and displaying multiple types of identification. The identification holder includes a base having a perimeter, a front side, and a rear side. A living hinge is disposed at a center of the base, such the living hinge divides the base into a first half and an adjacent second half. The base is foldable about the living hinge so that it may be folded to a compact configuration for storage when not in use. A plurality of transparent sleeves are disposed on the front side of the base, each sleeve including an open upper end and a closed lower end. One or more opaque pockets are disposed on the front side of the base, each of the one or more opaque pocket including an open upper end and a closed lower end. One or more clips are secured to the base, the one or more clips including a first member disposed on the front side of the base hingedly coupled to a second member disposed on the rear side of the base, wherein the second member is biased toward the base. The one or more clips are configured to removably secure the identification holder to a vehicle window.

An object of the present invention is to provide an identification holder that is securable to a vehicle window in order to make identification and other documents visible to a police officer to increase the safety of all individuals involved in a traffic stop.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front view of the identification holder.

FIG. 2 shows a rear view of the identification holder.

FIG. 3 shows a perspective view of the identification holder secured to a vehicle window.

### DETAILED DESCRIPTION OF THE INVENTION

Reference is made herein to the attached drawings. Like reference numerals are used throughout the drawings to depict like or similar elements of the identification holder. For the purposes of presenting a brief and clear description of the present invention, the preferred embodiment will be discussed as used for visibly storing multiple forms of identification. The figures are intended for representative purposes only and should not be considered to be limiting in any respect.

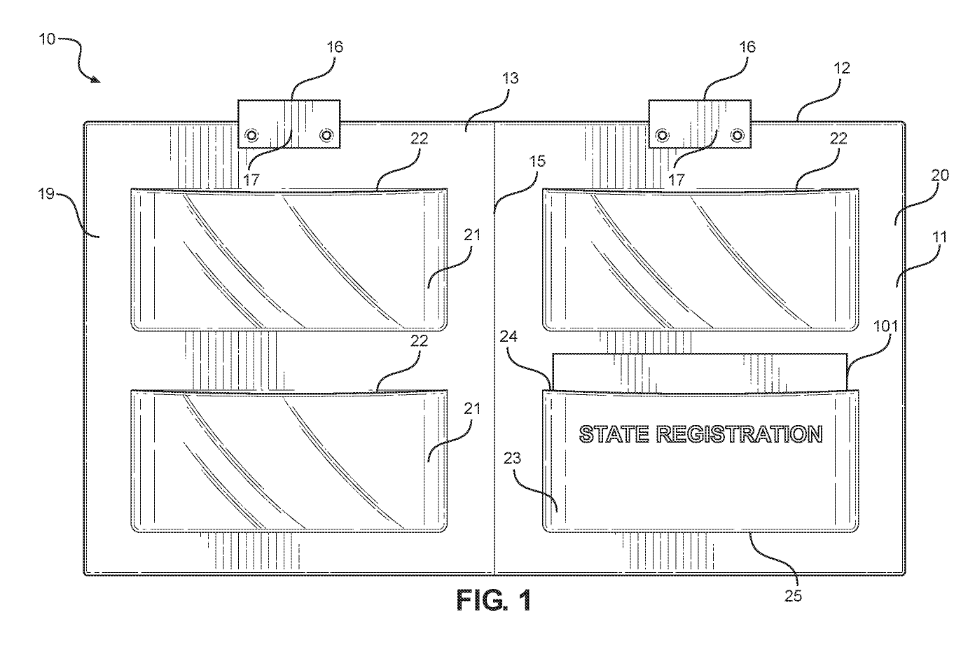

Referring now to FIG. 1, there is shown a front view of the identification holder. The identification holder 10 includes a base 11 having a rectangular perimeter edge 12. The base 11 includes a uniform width and a uniform length, which allows the identification holder 10 to be more cheaply manufactured and further allows the identification holder 10 to occupy the standard rectangular shaped space of a glove compartment when stored. A living hinge 15 is disposed on a center of the base 11 and extends between latitudinal edges of the base. The living hinge 15 divides the base into a first half 19 and a second half 20. The base 11 can be folded about the living hinge 15 such that the first half 19 and the second half 20 are stacked on one another, allowing the identification holder 10 to maintain a compact configuration for storage purposes when the identification holder 10 is not in use.

The identification holder 10 further includes a plurality of transparent sleeves 21 disposed on a front side 13 of the base 11. Each transparent sleeve 21 includes an open upper end 22 and a closed lower end. The transparent sleeves 21 are configured to receive and visibility display identification card therein, such as a driver's license or a vehicle insurance card. The identification holder 10 also includes one or more opaque pockets 23 having an open upper end 24 and a closed lower end. The opaque pockets 23 are configured to store documents that do not necessarily identify the driver of the vehicle, such as vehicle state registration paperwork, or any other documents that the driver does not wish to be visible.

The opaque pocket 23 may include indicia 25 on an outer surface thereof that identify the contents of the opaque pocket 23. In the shown embodiment, the identification holder 10 includes a first transparent 21 sleeve disposed on an upper portion of the first half 19 of the front side 13 of the base 11, a second transparent sleeve 21 disposed on a lower portion of the first half 19 of the front side 13 of the base 11, and a third transparent sleeve 21 disposed on an upper portion of the second half 20 of the front side 13 of the base 11. Further, the shown embodiment includes a first opaque pocket 23 disposed on a lower portion of the second half 20 of the front side 13 of the base 11 under the third transparent sleeve 21.

In the illustrated embodiment, the number and positioning of the transparent sleeves 21 and the opaque pocket 32 are optimized to provide maximum visibility to a police officer viewing the displayed contents of the identification holder 10, so that the police officer can easily characterize and obtain the required information. In alternate embodiments of the invention, the identification holder 10 may include a greater or lesser number of either transparent sleeves 21 or opaque pockets 23. Further, the transparent sleeves 21 and opaque pockets 23 can be disposed anywhere on the front side 13 of the base 11 of the identification holder 10.

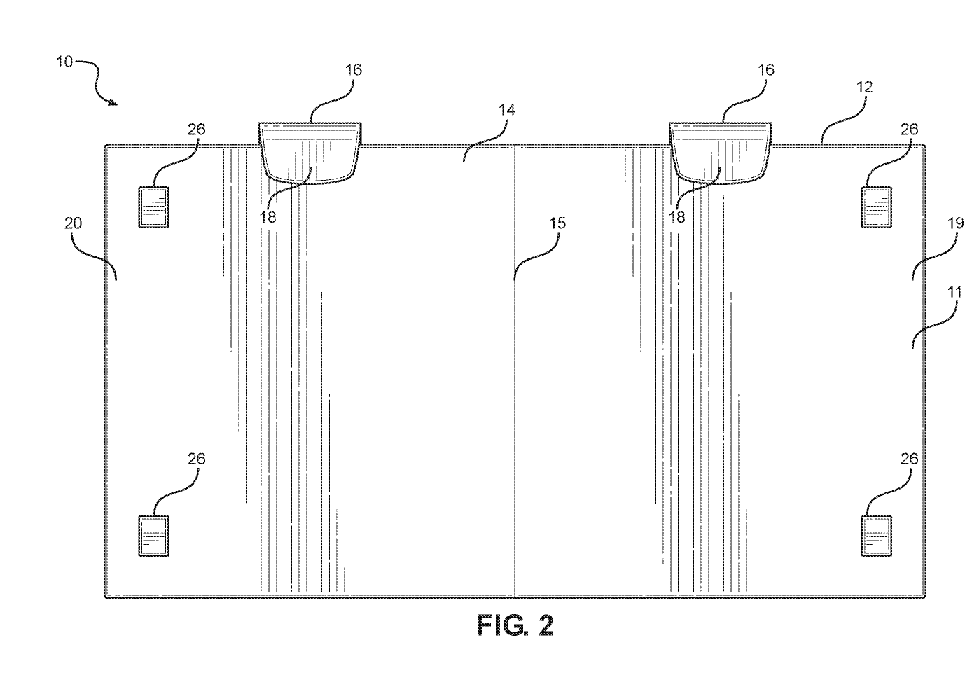

Referring now to FIG. 2, there is shown a rear view of the identification holder. The identification holder 10 further includes one or more clips 16 configured to secure the identification holder 10 to a window of the driver's vehicle. The clips 16 include a front portion (as seen in FIG. 1) disposed on the front side 13 of the base 11 and a rear portion 18 hingedly coupled to the front portion 17 disposed on the rear side 14 of the base 11. The rear portion 18 is biased toward the front portion 17, such that the rear portion 18 exerts a force against the rear side 14 of the base 11. The clips 16 may be utilized to secure the identification holder 10 to a window of a vehicle with the front side 13 of the base 11 facing outwardly such that the stored identification materials are visible from outside of the vehicle. In the shown embodiment, the identification holder 10 includes a first clip 16 disposed on the first half 19 of the base 11 and a second clip 16 disposed on the second half 20 of the base 11. The use of one clip 16 on each half of the base 11 allows the weight of the identification holder 10 to be evenly supported so that it is more effectively secured to a vehicle window when in use.

In one embodiment, the clips 16 are fixedly secured to the base 11. In an alternate embodiment, the clips 16 are removably secured to the base 11 and can be removed when the base 11 is folded up along the living hinge 15 for compact storage. The clips 16 can be removably secured to the base 11 via pressure from the biased rear portion 18 of the clips 16, such that the base 11 is supported between the front portion 17 and the rear portion 18 of each clip 16. The vehicle window can then be inserted between the base 11 and the rear portion 18 of the clips 16, wherein both the window and the base 11 are disposed between the front portion 17 and the rear portion 16 of each clip 16, such that base 11 contacts and outer side of the vehicle window.

In the shown embodiment, the identification holder 10 further comprises a plurality of magnets 26 disposed on the rear side 14 of the base 11. The plurality of magnets 26 may be utilized to secure the identification holder 10 to the body of the vehicle, such as, for example, to the outer side of the vehicle door. In the shown embodiment, the plurality of magnets includes a magnet 26 disposed at each corner of the rear side 14 of the base 11. This particular arrangement of magnets facilitates stable securement of the identification holder 10 to the outer side of the vehicle body. Alternate embodiments may include different number and arrangement of magnets 26.

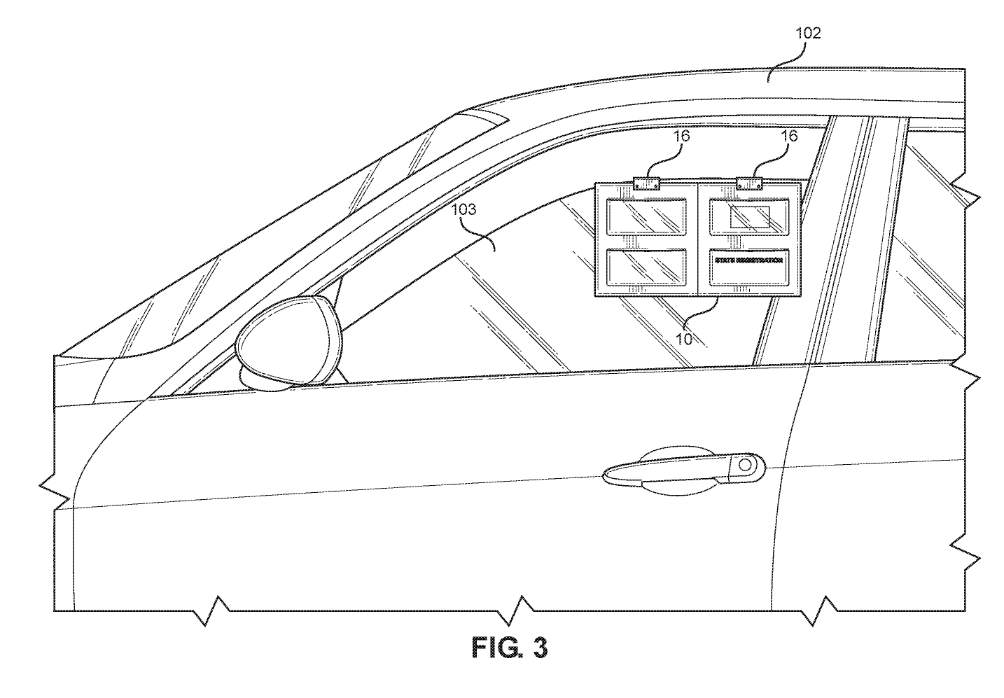

Referring now to FIG. 3, there is shown a perspective view of the identification holder secured to a vehicle window. In use, the driver may store his or her driver's license, vehicle registration, insurance card, and other documents in the identification holder 10, which may be folded up and stored when not needed. If the driver is pulled over by a police officer or other law enforcement agent, the driver may retrieve the identification holder 10 from its storage place. Before the police officer approaches the vehicle, the driver may unfold the identification holder 10, partially roll down the window 103 of the vehicle 102, and secure the clips 16 to the upper edge of the window 103, such that the identification holder is positioned against the outer surface of the window 103. This allows the police officer to access the documents of the identification holder without reaching into the vehicle cabin, and further eliminates the need for the driver to search for their identification information in the presence of the police officer. In this way, the driver's identification is easily visible and accessible to the police officer, and the lack of a need for hand movements significantly increases the safety of the traffic stop for both the driver and the police officer.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An identification holder, comprising:
a base having a perimeter, a front side, and a rear side;
a living hinge disposed at a center of the base, wherein the living hinge divides the base into a first half and an adjacent second half, wherein the base is foldable about the living hinge;
a plurality of transparent sleeves disposed on the front side of the base, each sleeve including an open upper end and a closed lower end;
one or more opaque pockets disposed on the front side of the base, each of the one or more opaque pocket including an open upper end and a closed lower end;
one or more clips secured to the base, the one or more clips comprising a first member disposed on the front side of the base hingedly coupled to a second member disposed on the rear side of the base, wherein the second member is biased toward the base;
wherein the one or more clips are configured to removably secure the base to a vehicle window.

2) The identification holder of claim 1, further comprising a plurality of magnets disposed on the rear side of the base.

3) The identification holder of claim 2, wherein each magnet of the plurality of magnets is disposed at a corner of the base.

4) The identification holder of claim 1, wherein the plurality of transparent sleeves includes a first sleeve disposed on an upper portion of the first half of the front side of the base, a second sleeve disposed on a lower portion of the first half of the front side of the base, and a third sleeve disposed on an upper portion of the second half of the front side of the base.

5) The identification holder of claim 4, wherein the opaque pocket is disposed on a lower portion of the second half of the front side of the base under the third sleeve.

6) The identification holder of claim 1, wherein the perimeter of the base includes a rectangular having a uniform length and a uniform width.

7) The identification holder of claim 1, wherein at east one of the plurality of transparent sleeves is sized to snuggly receive a driver's license therein.

8) The identification holder of claim 1, further comprising indicia disposed on an outer surface of the opaque pocket.

9) The identification holder of claim 1, wherein the one or more clips include a first clip disposed on the first half of the base and a second clip disposed on a second half of the base.

10) The identification holder of claim 9, wherein the one or more clips are removably secured to the base.
